(19) United States
(12) Patent Application Publication
(10) Pub. No.: US 2009/0310115 A1
(43) Pub. Date: Dec. 17, 2009

(54) APPARATUS AND METHOD FOR EXPOSING ADJACENT SITES ON A SUBSTRATE

(75) Inventors: W. Thomas Novak, Hillsborough, CA (US); Michael B. Binnard, Belmont, CA (US)

Correspondence Address: Roeder & Broder LLP, 5560 Chelsea Avenue, La Jolla, CA, 92037, US

(73) Assignee: Nikon Corporation, Tokyo (JP)

(21) Appl. No.: 12/469,619

(22) Filed: May 20, 2009

Related U.S. Application Data
(60) Provisional application No. 61/061,034, filed on Jun. 12, 2008.
(60) Provisional application No. 61/174,381, filed on Apr. 30, 2009.
(60) Provisional application No. 61/179,677, filed on May 19, 2009.

(51) Int. Cl. G03B 27/58

(52) U.S. Cl. 355/74; 355/77

(57) ABSTRACT

An exposure apparatus (10) for transferring a mask pattern (452) from a mask (12) to a substrate (14) includes an illumination system (18), a mask stage assembly (22), a substrate stage assembly (24), and a control system (28). The substrate (14) includes a first site (1) and a second site (2) that are adjacent to each other and that are aligned with each other along a first axis. The illumination system (18) generates an illumination beam (35) that is directed at the mask (12). The mask stage assembly (22) retains and positions the mask (12) relative to the illumination beam (35). The substrate stage assembly (24) retains and positions the substrate (14). The control system (28) controls the illumination system (18) and the substrate stage assembly (24) so that the mask pattern (452) is sequentially transferred to the first site (1) and then the second site (2) while the substrate stage assembly (24) is moving the substrate (24) in a first mask direction along the first axis. With this design, the substrate (14) is being moved in the same direction along the first axis during the exposure of successive sites (1) (2) and there is no need to stop the substrate (14) and/or reverse the direction of the substrate (14) during the exposure of successive sites (1) (2). This allows the exposure apparatus (1) to have improved throughput for a given acceleration and deceleration profile.

### RELATED INVENTIONS

This application claims priority on U.S. Provisional Application Ser. No. 61/061,034, filed Jun. 12, 2008 and entitled “HYBRID LITHOGRAPHY SYSTEM USING ELEMENTS OF STEPPER AND SCANNER TYPE SYSTEMS”, U.S. Provisional Application Ser. No. 61/174,381 filed Apr. 30, 2009, entitled “APPARATUS AND METHOD FOR EXPOSING ADJACENT SITES ON A SUBSTRATE”, and U.S. Provisional Application Ser. No. 61/179,677 filed May 19, 2009 entitled “APPARATUS AND METHOD FOR EXPOSING ADJACENT SITES ON A SUBSTRATE.” As far as permitted, the contents of U.S. Provisional Application Ser. Nos. 61/061,034, 61/174,381 and 61/179,677 are incorporated herein by reference.

### BACKGROUND

Exposure apparatuses for semiconductor processing are commonly used to transfer features from a reticle onto a semiconductor wafer during semiconductor processing. A typical exposure apparatus includes an illumination source, a reticle stage assembly that positions a reticle, an optical assembly, and a wafer stage assembly that positions a semiconductor wafer. Typically, the wafer is divided into a plurality of rectangular shaped chip sites, where the exposure apparatus typically creates integrated circuits.

There are two kinds of exposure apparatuses that are generally known and currently used. The first kind is commonly referred to as a Stepper lithography system. In a Stepper lithography system, the reticle is fixed (except for slight corrections in position) and the wafer stage assembly moves the wafer to fixed chip sites where the illumination source directs an illumination beam at an entire reticle pattern on the reticle. This causes the entire reticle pattern to be exposed onto one of the chip sites of the wafer at one time. At the time of exposure, the reticle and the wafer are substantially stationary. After the exposure, the wafer is moved (“stepped”) to the next site for a subsequent exposure. In this type of system, the throughput of the apparatus is largely governed by how quickly the wafer stage assembly accelerates and decelerates the wafer between exposures during movement between sites.

The second kind of system is commonly referred to as a Scanner lithography system. In a Scanner lithography system, the reticle stage assembly moves the reticle concurrently with the wafer stage assembly moving the wafer during the exposure process. With this system, the illumination beam is slit shaped and illuminates only a portion of the reticle pattern on the reticle. With this design, only a portion of the reticle pattern is exposed and transferred to the site on the wafer at a given moment, and the entire reticle is exposed and transferred to the site on the wafer over time as the reticle pattern and the wafer are moved through the exposure slit. After the entire site is exposed, (i) the wafer stage assembly decelerates the wafer in the scanning (Y) direction and subsequently accelerates the wafer in the opposite Y direction, (ii) the wafer stage accelerates and subsequently decelerates the wafer in the X direction to produce a step motion in the X direction to the next site, and (iii) the reticle stage assembly decelerates the reticle and subsequently accelerates the reticle in the opposite direction so that the reticle is moving in the opposite direction during the exposure of the next site. In this type of system, the throughput of the apparatus is largely governed by how quickly the wafer stage assembly accelerates and decelerates the wafer, and how quickly the reticle stage assembly accelerates and decelerates the reticle.

There is a never ending search to increase the throughput in terms of exposures per hour for the exposure apparatuses. With the current exposure apparatuses, assuming that there is sufficient light to adequately expose the wafer, in order to gain higher throughput, it is necessary to move the wafer and/or reticle at higher speeds, and accelerations. Unfortunately, it is not always easy to merely increase the velocities and accelerations of the wafer and the reticle.

### SUMMARY

The present invention is directed to an exposure apparatus for transferring a mask pattern from a mask to a substrate that includes a first site and a second site that are adjacent to each other and that are aligned with each other along a first axis. In one embodiment, the exposure apparatus includes an illumination system, a mask stage assembly, a substrate stage assembly, and a control system. The illumination system generates an illumination beam that is directed at the mask. The mask stage assembly retains and positions the mask relative to the illumination beam. The substrate stage assembly retains and positions the substrate. The control system controls the illumination system and the substrate stage assembly so that the mask pattern is sequentially transferred to the first site and then the second site while the substrate stage assembly is moving the substrate in a first substrate direction along the first axis.

With this design, the substrate is moving in the same direction along the first axis during the exposure of successive sites. As a result thereof, there is no need to stop the substrate and/or reverse the direction of the substrate during the exposure of successive sites. This reduces the acceleration and deceleration requirements of the substrate stage assembly and allows the exposure apparatus to have improved throughput for a given acceleration and deceleration profile.

In one embodiment, the control system also controls the mask stage assembly so that the mask is being moved synchronously with the wafer while the mask pattern is being transferred to the first site and while the mask pattern is being transferred to the second site. Depending upon the design of exposure apparatus, the mask and the substrate can be moved in the same direction or in different directions during the exposure of the first site. For example, the mask stage assembly can be controlled so that the mask is being moved along the first axis while the mask pattern is being transferred to the first site, and the mask is again being moved in the same direction along the first axis while the mask pattern is being transferred to the second chip site. More specifically, the mask stage assembly can be controlled to move the mask from a first mask position to a second mask position while the mask pattern is being transferred to the first site, and the mask stage assembly can again be controlled to move the mask from the first mask position to the second mask position while the mask pattern is being transferred to the second site. In this embodiment, the mask stage assembly is controlled to move the mask from the second mask position to the first mask position in between when the mask pattern is being transferred to the first site and the second site.

In certain embodiments, the substrate stage assembly is controlled to move the substrate without stopping the substrate during the transfer of the mask pattern to the first site and the second site. Further, the substrate stage assembly can be controlled to move the substrate without stopping between exposures of adjacent sites. As provided herein, the substrate stage assembly can be controlled to move the substrate at a constant velocity or a variable velocity between exposures of adjacent sites. For example, the substrate stage assembly can be controlled to move the substrate at a faster velocity or a slower velocity in between the exposure of adjacent sites.

The present invention is also directed to an exposure apparatus for transferring a mask pattern from a mask to a substrate. In this embodiment, the exposure apparatus includes (i) a mask stage assembly that retains and positions the mask along a first axis, (ii) an illumination system that generates an illumination beam that illuminates the entire mask pattern (or the portion of the mask pattern corresponding to all of the site) at once, (iii) a substrate stage assembly that retains and positions the substrate along the first axis, and (iv) a control system that controls the mask stage assembly so that the mask is being moved along the first axis and that controls the substrate stage assembly so that substrate is being moved in the first substrate direction along the first axis while the entire mask pattern (or the portion of the mask pattern corresponding to all of the site) is being transferred to the first site.

Additionally, the present invention is directed to a method for transferring a mask pattern from a mask to a substrate. In one embodiment, the method includes the steps of (i) generating an illumination beam with an illumination system, (ii) positioning the mask relative to the illumination beam with a mask stage assembly, (iii) positioning the substrate along the first axis with a substrate stage assembly, and (iv) controlling the illumination system, and the substrate stage assembly so that mask pattern is transferred to the first site and then subsequently to the second site. In this embodiment, the substrate stage assembly is moving the substrate in the first substrate direction along the first axis when the mask pattern is being transferred to the first site and the second site.

Moreover, the present invention is directed to a method for manufacturing a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2A is a simplified top view of one non-exclusive embodiment of a substrate that was processed with the exposure apparatus of FIG. 1;

FIG. 2B is a simplified top view of another non-exclusive embodiment of a substrate that was processed with the exposure apparatus of FIG. 1;

FIG. 3A is a simplified side illustration of a mask and a portion of the substrate at the start of an exposure of a first site;

FIG. 3B is a simplified side illustration of the mask and a portion of the substrate near the end of the exposure of the first site;

FIG. 3C is a simplified side illustration of the mask and a portion of the substrate between the exposure of the first site and a second site;

FIG. 3D is a simplified side illustration of the mask and a portion of the substrate at the start of an exposure of the second site;

FIG. 3E is a simplified side illustration of the mask and a portion of the substrate near the end of the exposure of the second site;

FIG. 4A is a simplified top illustration of the mask and a portion of the substrate in a side-by-side arrangement at the start of the exposure of the first site;

FIG. 4B is a simplified top illustration of the mask and a portion of the substrate in a side-by-side arrangement near the end of the exposure of the first site;

FIG. 4C is a simplified top illustration of the mask and a portion of the substrate in a side-by-side arrangement between the exposure of the first site and the second site;

FIG. 4D is a simplified top illustration of the mask and a portion of the substrate in a side-by-side arrangement at the start of an exposure of the second site;

FIG. 5A is a graph that illustrates one example of the position of the mask and the position of the substrate during the exposure of three adjacent sites versus time;

FIG. 5B is a graph that illustrates another example of the position of the mask and the position of the substrate during the exposure of three adjacent sites versus time;

FIG. 5C is a graph that illustrates yet another example of the position of the mask and the position of the substrate during the exposure of three adjacent sites versus time;

FIG. 6 is a simplified top illustration of another embodiment of the mask and the substrate in a side-by-side arrangement at the start of an exposure of the first site;

FIG. 7A is a flow chart that outlines a process for manufacturing a device in accordance with the present invention; and

FIG. 7B is a flow chart that outlines device processing in more detail.

### DESCRIPTION

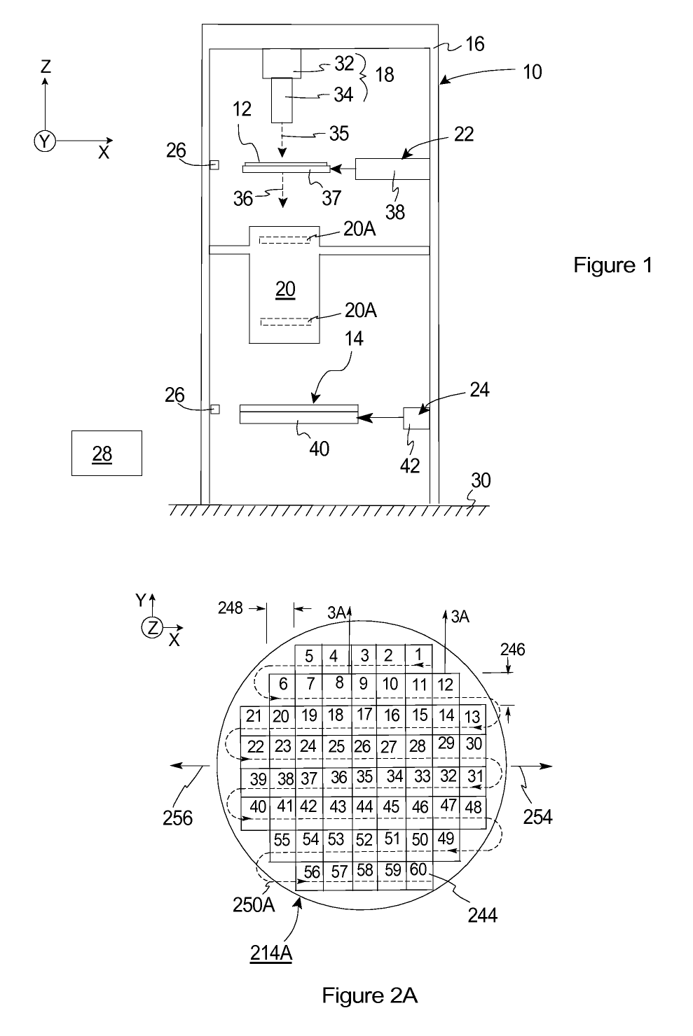

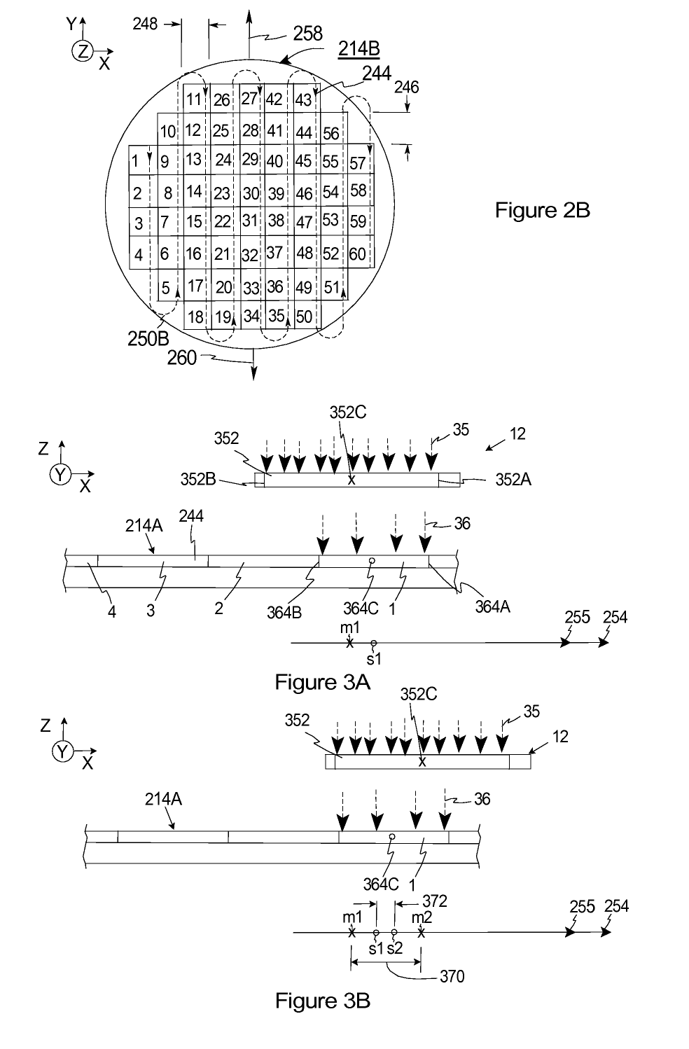

FIG. 1 is a schematic illustration of a precision assembly, namely an exposure apparatus 10 that transfers features from a mask 12 to a substrate 14 such as a semiconductor wafer. As an overview, in certain embodiments, the exposure apparatus 10 is designed so that the mask 12 and the substrate 14 are moved in a unique fashion that improves the overall throughput of the exposure apparatus 10. For example, in certain embodiments, the exposure apparatus 10 is designed so that an entire site 244 (illustrated in FIG. 2A) is exposed while the mask 12 and the substrate 14 are both being moved. With this design, adjacent sites 244 on the substrate 14 can be sequentially exposed without stopping the substrate 14 and without changing the movement direction of substrate 14. This allows for higher overall throughput for the exposure apparatus 10.

The exposure apparatus 10 discussed herein is particularly useful as a photolithography system for semiconductor manufacturing that transfers features from a reticle (the mask 12) to a wafer (the substrate 14). However, the exposure apparatus 10 provided herein is not limited to a photolithography system for semiconductor manufacturing. The exposure apparatus 10, for example, can be used as an LCD photolithography system that exposes a liquid crystal display device pattern onto a glass plate or a photolithography system for manufacturing a thin film magnetic head.

It should be noted that a number of Figures include an orientation system that illustrates an X axis, a Y axis that is orthogonal to the X axis and a Z axis that is orthogonal to the X and Y axes. Further, any of these axes can also be referred to as the first, second, and/or third axes.

The design of the exposure apparatus 10 can be varied to achieve the desired throughput, and quality and density of the features on the substrate 14. In FIG. 1, the exposure apparatus 10 includes an apparatus frame 16, an illumination system 18 (irradiation apparatus), an optical assembly 20, a mask stage assembly 22, a substrate stage assembly 24, a measurement system 26, and a control system 28. Further, the exposure apparatus 10 mounts to a mounting base 30, e.g., the ground, a base, or floor or some other supporting structure.

The apparatus frame 16 is rigid and supports the components of the exposure apparatus 10. The apparatus frame 16 illustrated in FIG. 1 supports the mask stage assembly 22, the projection optical assembly 20, the illumination system 18, and the substrate stage assembly 24 above the mounting base 30.

The illumination system 18 includes an illumination source 32 and an illumination optical assembly 34. The illumination source 32 emits an illumination beam 35 (irradiation) of light energy. The illumination optical assembly 34 guides the illumination beam 35 from the illumination source 32 to the mask 12. The illumination beam 35 illuminates the mask 12 to generate a pattern beam 36 (e.g. images from the mask 12) that exposes the substrate 14.

In FIG. 1, the mask 12 is at least partly transparent, and the illumination beam 35 from the illumination system 18 is transmitted through a portion of the mask 12. Alternatively, the mask 12 can be reflective, and the illumination beam 35 can be directed at the bottom of the mask 12.

As non-exclusive examples, the illumination source 32 can be a g-line source (436 nm), an i-line source (365 nm), a KrF excimer laser (248 nm), an ArF excimer laser (193 nm) or an F₂ laser (157 nm).

In certain embodiments, the exposure apparatus 10 includes a mask blind (not shown) positioned between the illumination source 32 and the mask 12 that blocks portions of the illumination beam 35 that fall outside a pattern area of the mask 12.

The projection optical assembly 20 projects and/or focuses the pattern beam 36 from the mask 12 to the substrate 14. Depending upon the design of the exposure apparatus 10, the projection optical assembly 20 can magnify or reduce the pattern beam 36. In one non-exclusive embodiment, the projection optical assembly 20 reduces the pattern beam 36 by a reduction factor of four. As a result thereof, during the exposure of a site 244 (illustrated in FIG. 2A), the mask stage assembly 22 must move the mask 12 a distance that is four times greater than a distance in which the substrate stage assembly 24 moves the substrate 14. Stated in another fashion, if the projection optical assembly 20 has a reduction factor of 4, the substrate 14 is moved during exposure at a rate that is four times slower than the mask 12.

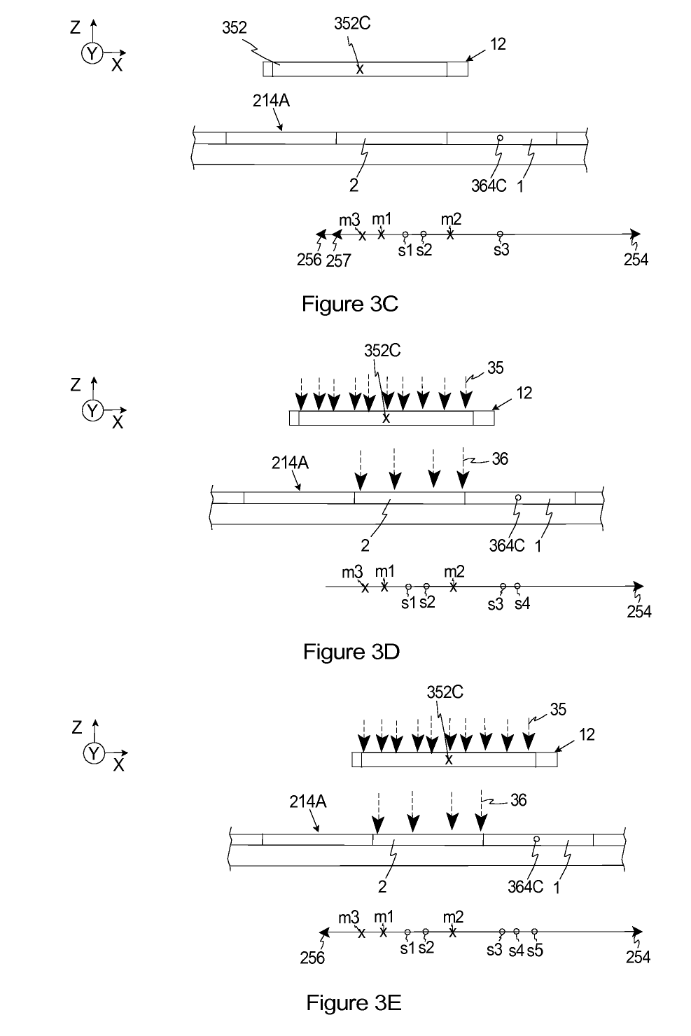

In certain embodiments, as discussed in more detail below, the projection optical assembly 20 includes a plurality of optical elements 20A (only two are illustrated in FIG. 1) that are designed and arranged so that the projection optical assembly 20 will have a relatively large field of view so that the portion of the mask pattern corresponding to all of the site, e.g. an entire mask pattern 352 (illustrated in FIG. 3A) in certain embodiments, can be transferred at one time to a site 244 of the substrate 14. A discussion of possible field of views for the projection optical assembly 20 is described in more detail below.

The mask stage assembly 22 holds and positions the mask 12 relative to the projection optical assembly 20 and the substrate 14. The mask stage assembly 22 can include a mask stage 37, and a mask stage mover assembly 38. The size, shape, and design of each these components can be varied. The mask stage 37 retains the mask 12. In one embodiment, the mask stage 37 can include a chuck (not shown) for holding the mask 12.

The mask stage mover assembly 38 moves and positions the mask stage 37 and the mask 12. For example, the mask stage mover assembly 38 can move the mask stage 37 and the mask 12 along the Y axis, along the X axis, and about the Z axis. Alternatively, for example, the mask stage mover assembly 38 could be designed to move the mask stage 37 and the mask 12 with more than three degrees of freedom, or less than three degrees of freedom. For example, the mask stage mover assembly 38 can include one or more linear motors, rotary motors, planar motors, voice coil actuators, or other type of actuators.

Somewhat similarly, the substrate stage assembly 24 holds and positions the substrate 14 with respect to the pattern beam 36. The substrate stage assembly 24 can include a substrate stage 40, and a substrate stage mover assembly 42. The size, shape, and design of each these components can be varied. The substrate stage 40 retains the substrate 14. In one embodiment, the substrate stage 40 can include a chuck (not shown) for holding the substrate 14.

The substrate stage mover assembly 42 moves and positions the substrate stage 40 and the substrate 14. For example, the substrate stage mover assembly 42 can move the substrate stage 40 and the substrate 14 along the Y axis, along the X axis, and about the Z axis. Alternatively, for example, the substrate stage mover assembly 42 could be designed to move the substrate stage 40 and the substrate 14 with more than three degrees of freedom, or less than three degrees of freedom. For example, the substrate stage mover assembly 42 can include one or more linear motors, rotary motors, planar motors, voice coil actuators, or other type of actuators.

The measurement system 26 monitors movement of the mask 12 and the substrate 14 relative to the projection optical assembly 20 or some other reference. With this information, the control system 28 can control the mask stage assembly 22 to precisely position the mask 12 and the substrate stage assembly 24 to precisely position the substrate 14. For example, the measurement system 26 can utilize multiple laser interferometers, encoders, and/or other measuring devices.

The control system 28 is connected to the mask stage assembly 22, the substrate stage assembly 24, and the measurement system 26. The control system 28 receives information from the measurement system 26 and controls the stage assemblies 30, 32 to precisely position the mask 12 and the substrate 14. Further, the control system 28 can control the operation of the illumination system 18. The control system 28 can include one or more processors and circuits. In FIG. 1, the control system 28 is illustrated as a single unit. It should be noted that the control system 28 can be designed with multiple, spaced apart controllers.

FIG. 2A is a simplified top view of one non-exclusive embodiment of a substrate 214A that has been processed with the exposure apparatus 10 of FIG. 1. In this embodiment, the substrate 214A is a generally disk shaped, thin slice of semiconductor material, e.g. a semiconductor wafer, that serves as a substrate for photolithographic patterning. Typically, the disk shaped substrate 214A is divided into a plurality of rectangular shaped sites 244 (e.g. chips) that are organized into a plurality of rows (along the X axis) and columns (along the Y axis). As used herein the term “site” shall mean an area on the substrate 214A in which the entire or a part of the mask pattern 352 (illustrated in FIG. 3A) has been transferred. For example, for a semiconductor wafer, each site 244 is one or more integrated circuits that include a number of connected circuit elements that were transferred to the substrate 214A by the exposure apparatus 10 of FIG. 1. In this example, each site 244 contains one or more integral die piece(s) that can be sliced from the wafer.

In one embodiment, each site 244 is generally rectangular shaped and has a length 246 (measured along the Y axis) that is greater than a width 248 (measured along the X axis). In one non-exclusive embodiment, each site 224 has a length 246 of approximately thirty-three (33) millimeters and a width 248 of approximately twenty-six (26) millimeters. Alternatively, for example, each site 224 can have a length 246 that is greater or less than thirty-three (33) millimeters, and a width 248 that is greater or less than twenty-six (26) millimeters.

The size of substrate 214A and the number of sites 244 on the substrate 214A can be varied. For example, the substrate 214A can have a diameter of approximately three hundred millimeters. Alternatively, the substrate 214A can have a diameter that is greater than or less than three hundred millimeters and/or the substrate 214A can have a shape that is different than disk shaped (e.g. rectangular shaped).

Further, in the embodiment illustrated in FIG. 2A, the substrate 214A is illustrated as having sixty separate sites 244. Alternatively, for example, the substrate 214A can be separated into greater than or fewer than sixty sites 244.

In FIG. 2A, the sites 244 have been labeled “1”-“60” (one to sixty). In this example, (i) the sites 244 labeled “1”-“5” are aligned in a first row along the X axis; (ii) the sites 244 labeled “6”-“12” are aligned in a second row along the X axis; (iii) the sites 244 labeled “13”-“21” are aligned in a third row along the X axis; (iv) the sites 244 labeled “22”-“30” are aligned in a fourth row along the X axis; (v) the sites 244 labeled “31”-“39” are aligned in a fifth row along the X axis; (vi) the sites 244 labeled “40”-“48” are aligned in a sixth row along the X axis; (vii) the sites 244 labeled “49”-“55” are aligned in a seventh row along the X axis; and (viii) the sites 244 labeled “56”-“60” are aligned in an eighth row along the X axis.

Additionally, the labels “1”-“60” represent one non-exclusive embodiment of the sequence in which the mask pattern 352 can be transferred to the sites 244 on the substrate 214A. More specifically, as provided herein, the exposure apparatus 10 can first transfer the mask pattern 352 to the site 244 labeled “1” (sometimes referred to as the “first site”). Next, the exposure apparatus 10 can move the mask 12 (illustrated in FIG. 1) and the substrate 214A, and transfer the mask pattern 352 to the site 244 labeled “2” (sometimes referred to as the “second site”). Subsequently, and sequentially, the exposure apparatus 10 can move the mask 12 and the substrate 214A to transfer the mask pattern 352 to the sites 244 labeled “3”, “4”, “5”, “6”, “7”, “8”, “9”, “10”, “11”, “12”, “13”, “14”, “15”, “16”, “17”, “18”, “19”, “20”, “21”, “22”, “23”, “24”, “25”, “26”, “27”, “28”, “29”, “30”, “31”, “32”, “33”, “34”, “35”, “36”, “37”, “38”, “39”, “40”, “41”, “42”, “43”, “44”, “45”, “46”, “47”, “48”, “49”, “50”, “51”, “52”, “53”, “54”, “55”, “56”, “57”, “58”, “59”, and “60”.

Moreover, FIG. 2A includes a dashed line 250A that further illustrates the order in which the mask pattern 352 can be transferred to the sites 244. In this example, (i) the sites 244 labeled “1”-“5” are sequentially exposed as the substrate 214A is moved in a first X substrate direction 254 (left to right in FIG. 2A) along the X axis; (ii) next, the sites 244 labeled “6”-“12” are sequentially exposed as the substrate 214A is moved in a second X substrate direction 256 (right to left in FIG. 2A) along the X axis; (iii) subsequently, the sites 244 labeled “13”-“21” are sequentially exposed as the substrate 214A is moved in the first X substrate direction 254; (iv) next, the sites 244 labeled “22”-“30” are sequentially exposed as the substrate 214A is moved in the second X wafer direction 256; (v) subsequently, the sites 244 labeled “31”-“39” are sequentially exposed as the substrate 214A is moved in the first X substrate direction 254; (vi) next, the sites 244 labeled “40”-“48” are sequentially exposed as the substrate 214A is moved in the second X substrate direction 256; (vii) subsequently, the sites 244 labeled “49”-“55” are sequentially exposed as the substrate 214A is moved in the first X substrate direction 254; and (viii) next, the sites 244 labeled “56”-“60” are sequentially exposed as the substrate 214A is moved in the second X substrate direction 256.

It should be noted that in this example, the site 244 that is exposed first and the order in which the rows are exposed can be different than that illustrated in FIG. 2A. Further, the site 244 that is first exposed can be located away from the edge of the substrate 214A

FIG. 2B is a simplified top view of another non-exclusive embodiment of a substrate 214B that has been processed with the exposure apparatus 10 of FIG. 1. In this embodiment, the substrate 214B has been processed in a different fashion than the substrate 214A illustrated in FIG. 2A. In FIG. 2B, the substrate 214B is again generally disk shaped and is divided into a plurality of rectangular shaped sites 244 (e.g. chips) that are organized into a plurality of rows and columns. In this embodiment, each site 244 is again generally rectangular shaped and has a length 246 (measured along the Y axis) that is greater than a width 248 (measured along the X axis).

Moreover, in FIG. 2B, the substrate 214B is again illustrated as having sixty sites 244 that have been labeled “1”-“60” (one to sixty). In this example, (i) the sites 244 labeled “1”-“4” are aligned in a first column along the Y axis; (ii) the sites 244 labeled “5”-“10” are aligned in a second column along the Y axis; (iii) the sites 244 labeled “11”-“18” are aligned in a third column along the Y axis; (iv) the sites 244 labeled “19”-“26” are aligned in a fourth column along the Y axis; (v) the sites 244 labeled “27”-“34” are aligned in a fifth column along the Y axis; (vi) the sites 244 labeled “35”-“42” are aligned in a sixth column along the Y axis; (vii) the sites 244 labeled “43”-“50” are aligned in a seventh column along the Y axis; (viii) the sites 244 labeled “51”-“56” are aligned in an eighth column along the Y axis; and (ix) the sites 244 labeled “57”-“60” are aligned in a ninth column along the Y axis

The labels “1”-“60” again represent one non-exclusive embodiment of the sequence in which the mask pattern 352 (illustrated in FIG. 3A) can be transferred to the sites 244 on the substrate 214B. As provided herein, the exposure apparatus 10 can first transfer the mask pattern 352 to the site 244 labeled “1”. Next, the exposure apparatus 10 can move the mask 12 (illustrated in FIG. 1) and the substrate 214B, and transfer the mask pattern 352 to the site 244 labeled “2”. Subsequently, and sequentially, the exposure apparatus 10 can move the mask 12 and the substrate 214B to transfer the mask pattern 352 to the sites 244 labeled “3”, “4”, “5”, . . . and “60”.

Moreover, FIG. 2B includes a dashed line 250B that further illustrates the order in which the mask pattern 352 can be transferred to the sites 244. In this example, (i) the sites 244 labeled “1”-“4” are sequentially exposed as the substrate 214B is moved in a first Y substrate direction 258 (bottom to top in FIG. 2B) along the Y axis; (ii) next, the sites 244 labeled “5”-“10” are sequentially exposed as the substrate 214B is moved in a second Y substrate direction 260 (top to bottom in FIG. 2B) along the Y axis; (iii) subsequently, the sites 244 labeled “11”-“18” are sequentially exposed as the substrate 214B is moved in the first Y substrate direction 258; (iv) next, the sites 244 labeled “19”-“26” are sequentially exposed as the substrate 214B is moved in the second Y substrate direction 260; (v) subsequently, the sites 244 labeled “27”-“34” are sequentially exposed as the substrate 214B is moved in the first Y substrate direction 258; (vi) next, the sites 244 labeled “35”-“42” are sequentially exposed as the substrate 214B is moved in the second Y substrate direction 260; (vii) subsequently, the sites 244 labeled “43”-“50” are sequentially exposed as the substrate 214B is moved in the first Y substrate direction 258; (viii) next, the sites 244 labeled “51”-“56” are sequentially exposed as the substrate 214A is moved in the second Y substrate direction 260; and (ix) subsequently, the sites 244 labeled “57”-“60” are sequentially exposed as the substrate 214B is moved in the first Y substrate direction 258.

It should be noted that in this example, the site 244 that is exposed first and the order in which the columns are exposed can be different than that illustrated in FIG. 2B.

FIG. 3A is a simplified side illustration of the mask 12 and the substrate 214A as taken on line 3A-3A in FIG. 2A, at the start of an exposure of the first site 1 (illustrated as a box). It should be noted that the components of the exposure apparatus 10 (illustrated in FIG. 1) are not shown in FIGS. 3A-3F for clarity.

FIG. 3A illustrates that the mask 12 includes the mask pattern 352 (illustrated as a box) that includes the features that are to be transferred to the substrate 214A. In this embodiment, the mask pattern 352 includes a first pattern side 352A, and opposed second pattern side 352B, and a pattern center 352C (illustrated as with an “x”). It should be noted that in FIGS. 3A-3D that the mask pattern 352 is illustrated as being longer than each site. In the event that the projection optical assembly 20 has a reduction factor of 4, the mask pattern 352 can be four times larger than the size of each site.

Further, in FIG. 3A, the second site 2, the third site 3, and a portion of the fourth 4 site are also illustrated as boxes. In this embodiment, each site 244 includes a first site side 364A, an opposed second site side 364B, and a site center 364C (illustrated with an “o”).

At the start of exposure of the first site 1, the control system 28 (illustrated in FIG. 1) controls the illumination system 18 (illustrated in FIG. 1) to generate the illumination beam 35 that is directed at the mask 12. This causes the resulting pattern beam 36 to be directed at the entire first site 1. It should be noted that in this embodiment, during the entire exposure of the first site 1, (i) the illumination beam 35 illuminates the portion of the mask pattern 352 that corresponds to all of the first site 1 (e.g. the entire mask pattern 352 in certain embodiments) at one time, and (ii) the first site 1 is exposed by the mask pattern 352 via the pattern beam 36 at one time. Alternatively, for example, the illumination beam 35 may only expose a portion of mask pattern 352 and only a portion of the site 1 is exposed at one time. In this embodiment, for example, the illumination beam 35 can illuminate approximately one half of the mask pattern 352 and approximately one half of the site 1 is exposed at one time.

At the beginning of the exposure of the first site 1, the pattern center 352C of the mask pattern 352 is located at a first mask position m1 along the first axis (X axis in FIG. 3A) and the site center 364C of the first site 1 is located at a first substrate position s1 along the first axis.

Further, at the beginning of the exposure, the control system 28 (illustrated in FIG. 1) (i) controls the mask stage assembly 22 (illustrated in FIG. 1) so that the mask 12 is being moved at a constant velocity in a first mask direction 255 along the X axis, and (ii) controls the substrate stage assembly 24 (illustrated in FIG. 1) so that the substrate 214A is being moved at a constant velocity in a first substrate direction 254 along the X axis. As illustrated in FIG. 3A, in certain embodiments, the first mask direction 255 is the same as the first substrate direction 254, and both the mask 12 and the substrate 214A are moved synchronously in the same direction 254 along the X axis. Alternatively, depending on the details of the projection optical assembly 20 (illustrated in FIG. 1 is a dioptric lens), the first mask direction 255 can be different from the first substrate direction 254, and the mask 12 and the substrate 214A can be moved in opposite directions during scanning. Further, for example, if the projection optical assembly 20 (illustrated in FIG. 1) has a reduction factor of four, the mask 12 is moved at a rate that is four times greater than the substrate 214A.

Alternatively, for example, the assembly can be designed so that the mask 12 and/or the substrate 214A are not being moved at a constant velocity during each exposure. In yet another alternative embodiment, the assembly can be designed so that the mask 12 and the substrate 214A are moved in opposite directions along the same axis or are moved orthogonal to each other during each exposure.

FIG. 3B is a simplified side illustration of the mask 12 and the substrate 214A from FIG. 3A, just prior to the end of the exposure of the first site 1. Just prior to the end of exposure of the first site 1, the control system 28 (illustrated in FIG. 1) controls the illumination system 18 (illustrated in FIG. 1) to generate the illumination beam 35 that is directed at the mask 12. This causes the resulting pattern beam 36 to be directed at the entire first site 1.

In this example, at the end of the exposure of the first site 1, (i) the pattern center 352C of the mask pattern 352 has been moved to a second mask position m2 along the first axis with the mask stage assembly 22 (illustrated in FIG. 1), and (ii) the site center 364C of the first site 1 has been moved to a second substrate position s2 along the first axis with the substrate stage assembly 24 (illustrated in FIG. 1).

Further, at this time, the control system 28 (illustrated in FIG. 1) (i) controls the mask stage assembly 22 (illustrated in FIG. 1) so that the mask 12 is still moving at a constant velocity in the first mask direction 255 along the X axis, and (ii) controls the substrate stage assembly 24 (illustrated in FIG. 1) so that the substrate 214A is still moving at a constant velocity in the first substrate direction 254.

It should be noted that (i) the difference between the first mask position m1 and the second mask position m2 is referred to herein as a mask exposure distance 370, and (ii) the difference between the first substrate position s1 and the second substrate position s2 is referred to herein as a site exposure distance 372. In this example, (i) the mask exposure distance 370 is the distance in which the mask 12 is moved during the exposure of the first site 1, and (ii) the site exposure distance 372 is the distance in which the substrate 314A is moved during the exposure of the first site 1. In the event the projection optical assembly 20 (illustrated in FIG. 1) has a reduction factor of four, the mask exposure distance 370 is four times larger than the site exposure distance 372.

Referring to FIGS. 3A and 3B, it should also be noted that the entire mask pattern 352 is illuminated during movement of the mask 12 the mask exposure distance 370. Further, because the mask 12 and the substrate 214A are being concurrently moved along the X axis (in the same or opposite directions) the pattern beam 36 is also being moved along the X axis. This causes the entire first site 1 to be exposed during movement of the substrate 214A the site exposure distance 372.

FIG. 3C is a simplified side illustration of the mask 12 and the substrate 214A between the exposure of the first site 1 and the second site 2. At this time, the control system 28 (illustrated in FIG. 1) controls the illumination system 18 (illustrated in FIG. 1) to not generate the illumination beam. Thus, there is also no illumination beam 35. Further, at this time, in this embodiment, the control system 28 (i) controls the mask stage assembly 22 (illustrated in FIG. 1) so that the mask 12 is being moved in the second mask direction 257 along the X axis, and (ii) controls the substrate stage assembly 24 (illustrated in FIG. 1) so that the substrate 214A is still being moved in the first substrate direction 254. A second substrate direction 256 is also illustrated in FIG. 3C.

Basically, in between exposures, (i) the position of the mask pattern 352 is reset from the second mask position m2 to the first mask position m1 along the first axis with the mask stage assembly 22 (illustrated in FIG. 1), and (ii) the second site 2 is being moved towards the field of view of the projection optical assembly 20 (illustrated in FIG. 1). It should be noted that the mask pattern 352 is moved past the second mask position m2 in the first mask direction 255 after the exposure because the mask 12 is moved at a constant velocity during the entire exposure and the mask 12 must be decelerated after the exposure. Further, the mask pattern 352 must be moved past the first mask position m1 in the second mask direction 257 to a third mask position m3 so that the mask 12 can subsequently be accelerated and can be at a constant velocity moving in the first mask direction 255 when the mask pattern 352 reaches the first mask position m1 during exposure of the second site 2. FIG. 3C also illustrates that the site center 364C of the first site 1 has been moved to a third substrate position s3 in the first X direction 254 along the first axis at this time.

FIG. 3D is a simplified side illustration of the mask 12 and the substrate 214A of FIG. 3A, at the start of an exposure of the second site 2. At the start of exposure of the second site 2, the control system 28 (illustrated in FIG. 1) controls the illumination system 18 (illustrated in FIG. 1) to generate the illumination beam 35 that is directed at the mask 12. This causes the resulting pattern beam 36 to be directed at the entire second site 2. It should be noted that in this embodiment, during the entire exposure of the second site 2, (i) the illumination beam 35 illuminates the entire mask pattern 352, and (ii) the second site 2 is exposed by the entire mask pattern 352 via the pattern beam 36. Alternatively, for example, the illumination beam 35 may only expose a portion of mask pattern 352 and only a portion of the site 2 is exposed at one time.

At the beginning of the exposure of the second site 2, the pattern center 352C of the mask pattern 352 is again located at the first mask position m1 along the first axis and the site center 364C of the first site 1 is located at a fourth substrate position s4 along the first axis. At this time the center of the second site 2 is at the first site position s1. It should be noted that the second and third mask positions m2, m3, and the first through third substrate positions s1, s2, s3 are also illustrated in FIG. 3D for reference.

Further, at the beginning of the exposure, the control system 28 (illustrated in FIG. 1) (i) controls the mask stage assembly 22 (illustrated in FIG. 1) so that the mask 12 is being moved at a constant velocity along the X axis, and (ii) controls the substrate stage assembly 24 (illustrated in FIG. 1) so that the substrate 214A is also being moved at a constant velocity in the first X direction 254.

FIG. 3E is a simplified side illustration of the mask 12 and the substrate 214A from FIG. 3A, just prior to the end of the exposure of the second site 2. Just prior to the end of exposure of the second site 2, the control system 28 (illustrated in FIG. 1) controls the illumination system 18 (illustrated in FIG. 1) to continue to generate the illumination beam 35 that is directed at the mask 12. This causes the resulting pattern beam 36 to be directed at the entire second site 2.

At the end of the exposure of the second site 2, in this example, (i) the pattern center 352C of the mask pattern 352 has been moved to the second mask position m2 along the first axis with the mask stage assembly 22 (illustrated in FIG. 1), (ii) the site center 364C of the first site 1 has been moved to a fifth substrate position s5 along the first axis with the substrate stage assembly 24 (illustrated in FIG. 1), and the center of the second site 2 has been moved to the second site position s2. In FIG. 3E, the first and third mask positions m1, m3, and the first through fourth substrate positions s1, s2, s3, s4 are also illustrated for reference.

Further, at this time, the control system 28 (illustrated in FIG. 1) (i) controls the mask stage assembly 22 (illustrated in FIG. 1) so that the mask 12 is still moving at a constant velocity in the first mask direction 255 along the X axis, and (ii) controls the substrate stage assembly 24 (illustrated in FIG. 1) so that the substrate 214A is still moving at a constant velocity in the first substrate direction 254.

Upon completion of the exposure of the second site 2 and before the exposure of the third site 3, (i) the position of the mask pattern 352 is reset from the second mask position m2 to the first mask position m1 along the first axis with the mask stage assembly 22 (illustrated in FIG. 1), and (ii) the third site 3 is being moved towards the field of view of the projection optical assembly 20 (illustrated in FIG. 1).

It should be noted that with the designs provided herein, the substrate 214A does not stop and continuously moves in the first substrate direction 254 along the X axis during the exposure of adjacent sites 1, 2, 3, and 4. Further, (i) the mask 12 is moved at a constant velocity from the first mask position m1 to the second mask position m2 along the X axis during exposures of sites 1, 2, 3, and 4, and (ii) the mask 12 is moved in the second X direction 256 to reset the mask 12 to the first mask position m1 in between exposures. Further, in this example, the exposures occur while the mask 12 and the substrate 214A are moving in the same direction. Alternatively, the exposures can occur with the mask 12 and substrate 214A being moved in opposite directions.

Additionally, it should be noted that during the sequential exposure of the sites 244 in the row that includes the sites labeled 1-5 (see FIG. 2A), the substrate 214A is continuously moved in the first substrate direction 254 along the X axis, and the mask 12 is moved from the first mask position m1 to the second mask position m2 during each exposure. In this example, the mask 12 is reset from the second mask position m2 to the first mask position m1 between exposures.

Alternatively, during the sequential exposure of the sites 244 in the row that includes the sites labeled 6-12 (see FIG. 2A), the substrate 214A is continuously moved in the second substrate direction 256 along the X axis, and the mask 12 is moved from the second mask position m2 to the first mask position m1 during each exposure. In this example, the mask 12 is reset from the first mask position m1 to the second mask position m2 between exposures.

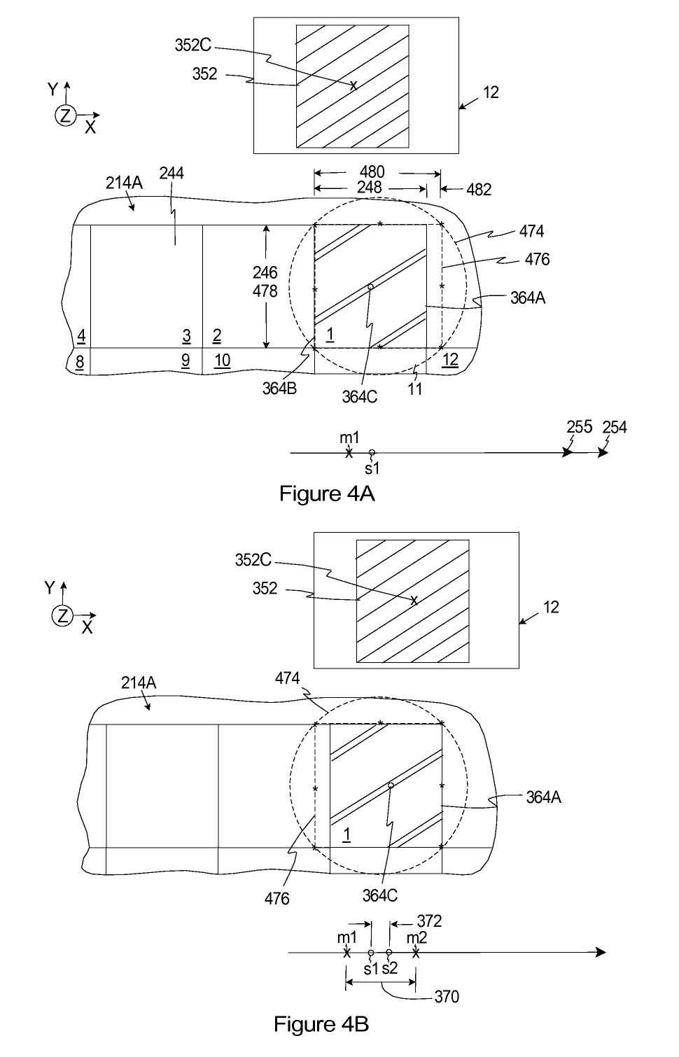

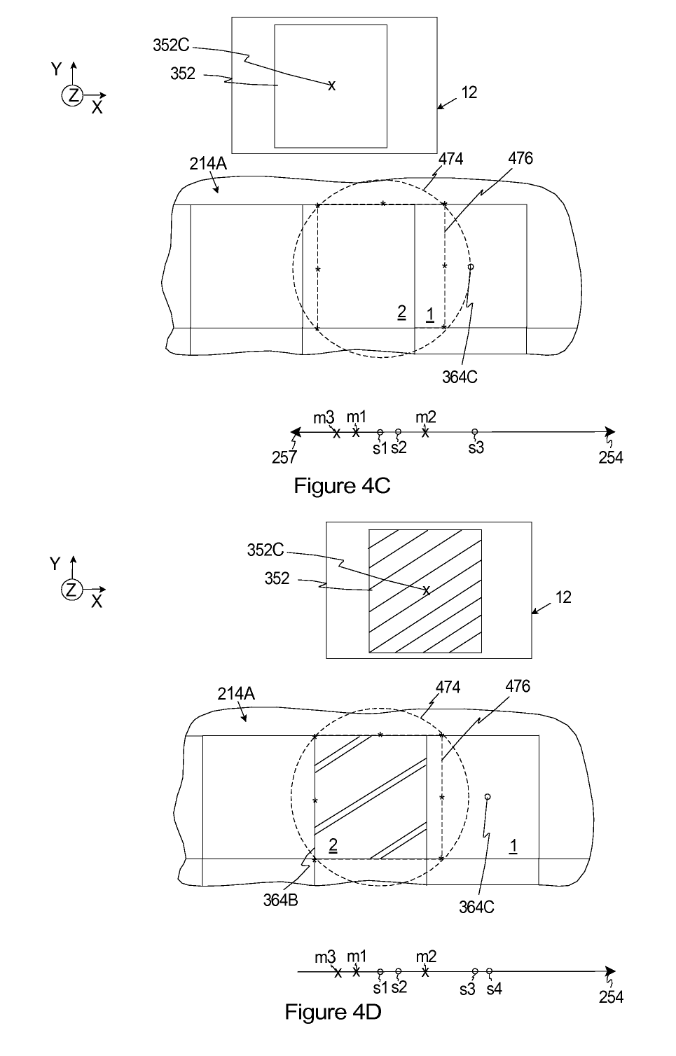

FIG. 4A is a simplified top illustration of the mask 12 and a portion of the substrate 214A in a side-by-side arrangement at the start of the exposure of the first site 1. It should be noted that the relative positions of the mask 12 and the substrate 214A illustrated in FIG. 4A are similar to that illustrated in FIG. 3A.

Additionally, it should be noted that the mask 12 and the substrate 214A are in a side-by-side arrangement and that FIGS. 4A-4D are only illustrated in this configuration so that the relative positions of these components can be better understood. Further, the components of the exposure apparatus 10 (illustrated in FIG. 1) are not shown in FIGS. 4A-4D for clarity.

FIG. 4A illustrates that the mask 12 includes the mask pattern 352 (illustrated as a box) that includes the features that are to be transferred to the substrate 214A. The pattern center 352C (illustrated as with an “x”) is also shown in FIG. 4A.

Additionally, in FIGS. 4A-4D, the mask pattern 352 is illustrated as being approximately the same size as each site 244. However, in the event that the projection optical assembly 20 has a reduction factor of 4, the mask pattern 352 can be four times larger than the size of each site 244.

Further, in FIG. 4A, the second site 2, the third site 3, and a portion of the fourth site 4, the eighth site 8, the ninth site 9, the tenth site 10, the eleventh site 11, and the twelfth site 12 are also illustrated as boxes. In this embodiment, each site 244 includes the first site side 364A, the second site side 364B, and the site center 364C (illustrated with an “o”).

At the start of exposure of the first site 1, the control system 28 (illustrated in FIG. 1) controls the illumination system 18 (illustrated in FIG. 1) to illuminate (illustrated with slashes “/”) the entire mask pattern 352. This causes the image (illustrated with double slashes “//”) of the mask pattern 352 to be directed at the entire first site 1 and to expose the first site 1.

At the beginning of the exposure of the first site 1, the pattern center 352C of the mask pattern 352 is located at a first mask position m1 along the first axis (X axis in FIG. 4A) and the site center 364C of the first site 1 is located at a first substrate position s1 along the first axis. Further, at the beginning of the exposure, (i) the mask 12 is being moved at a constant velocity in the first mask direction 255 along the X axis, and (ii) the substrate 214A is also being moved at a constant velocity in the first substrate direction 254 along the X axis. In this example, the mask 12 and substrate 214A are both moved in the same direction during the exposure process of each site. Alternatively, for example, the mask 12 and substrate 214A can be moved in opposite directions during the exposure process of each site.

A field of view 474 (illustrated with a dashed circle) of the projection optical assembly 20 (see FIG. 1) is also shown in FIG. 4A. As provided herein, in certain embodiments, the field of view 474 of the projection optical assembly 20 must be relatively large in order to transfer the entire image of the mask pattern 352 to a site 244 while the mask 12 and the substrate 214A are being moved concurrently. In one embodiment, the field of view 474 defines a rectangular shaped shot area 476 (illustrated with a dashed box with *'s) that is larger (along the direction of movement of the mask 12 and substrate 214A) than each individual site 244. More specifically, the shot area 476 has a shot length 478 (along the Y axis) and a shot width 480 (along the X axis). Further, in certain embodiments, the projection optical assembly 20 is designed so that the shot length 478 is equal to the site length 246, and the shot width 480 is greater than the site width 248. Further, the difference between the shot width 480 and the site width 248 is referred to as a width difference 482. With this design, as provided herein, the substrate 214A can be moved the width difference 482 while still being exposed by the image of the mask pattern 352.

In one non-exclusive example, each site 244 has the length 246 of thirty-three (33) millimeters, and a width 248 of twenty-six (26) millimeters. In this example, the shot length 478 can be approximately thirty-three (33) millimeters, and the shot width 480 is greater than twenty-six (26) millimeters. As non-exclusive examples, the shot width 480 can be approximately 28, 29, 29.5, 30, or 30.5 millimeters. In these non-exclusive examples, the width difference 482 is approximately 2, 3, 3.5, 4, or 4.5 millimeters. However, different shot widths 480 and different width differences 482 are possible by changing the design of the projection optical assembly 20. In certain embodiments, the mask blind, described above, would block any light that would fall into the width difference 482.

As provided herein, once the entire first site 1 is fully within the field of view 474, the mask pattern 352 is imaged onto the first site 1. Basically, with the substrate 214A and mask 12 moving along the X axis, the mask pattern 352 is illuminated once the complete second site side 364B reaches the shot area 476.

FIG. 4B is a simplified top illustration of the mask 12 and a portion of the substrate 214A in a side-by-side arrangement near the end of the exposure of the first site 1. It should be noted that the relative positions of the mask 12 and the substrate 214A illustrated in FIG. 4B are similar to that illustrated in FIG. 3B.

Just prior to the end of exposure of the first site 1, the illumination system 18 (illustrated in FIG. 1) is still illuminating (illustrated with slashes “/”) the entire mask pattern 352. This causes the image (illustrated with double slashes “//”) of the mask pattern 352 to be directed at the entire first site 1.

At the end of the exposure of the first site 1, (i) the pattern center 352C of the mask pattern 352 has been moved to the second mask position m2, and (ii) the site center 364C of the first site 1 has been moved to the second substrate position s2.

The field of view 474 (illustrated as a dashed circle) and the shot area 476 (illustrated with a dashed box with *'s) are also illustrated in FIG. 4B. Comparing FIGS. 4A and 4B, in one embodiment, during the exposure of the first site 1, the mask 12 has been moved the mask exposure distance 370 (difference between m2 and m1), and the substrate 214A has been moved the site exposure distance 372 (difference between s1 and s2). Thus, exposure of the first site 1 occurs during movement of the substrate 214A the site exposure distance 372.

Further, in this example, the width difference 482 (illustrated in FIG. 4A) is equal to the substrate exposure distance 372. As provided herein, the entire image of the mask pattern 352 can be directed at the first site 1 during movement of the substrate 214A the substrate exposure distance 372 as long as the width difference 482 is greater than or equal to the substrate exposure distance 372. Stated in another fashion, the entire image of the mask pattern 352 can be directed at the first site 1 as long as the substrate 214A is moved no greater than the width difference 482.

The exposure of the first site 1 is halted once the entire first site 1 is no longer fully within the field of view 474. Basically, in FIG. 4B, with the substrate 214A moving in the first substrate direction 254, the illumination of the mask pattern 352 is stopped once the first site side 364A begins to exit the shot area 476.

FIG. 4C is a simplified top illustration of the mask 12 and a portion of the substrate 214A in a side-by-side arrangement between the exposure of the first site 1 and the second site 2. The relative positions of the mask 12 and the substrate 214A illustrated in FIG. 4C are similar to that illustrated in FIG. 3C.

Between exposures, the illumination system 18 (illustrated in FIG. 1) is not illuminating the mask pattern 352, and the image of the mask pattern 352 is not directed at the substrate 214A. Further, in the embodiment illustrated in FIG. 4C, at this time, the mask 12 is being moved in the second mask direction 257, and the substrate 214A is still being moved in the first substrate direction 254. As provided above, in between exposures, (i) the position of the mask pattern 352 is reset from the second mask position m2 to the first mask position m1, and (ii) the second site 2 is being moved towards the shot area 476 of the field of view 474. In FIG. 4C, the third mask position m3, and the first and second substrate positions s1, s2 are illustrated for reference.

FIG. 4D is a simplified top illustration of the mask 12 and the substrate 214A in a side-by-side arrangement at the start of an exposure of the second site 2. The relative positions of the mask 12 and the substrate 214A illustrated in FIG. 4D are similar to that illustrated in FIG. 3D.

At the start of exposure of the first site 2, the illumination system 18 (illustrated in FIG. 1) illuminates (illustrated with slashes “/”) the entire mask pattern 352. This causes the image (illustrated with double slashes “//”) of the mask pattern 352 to be directed at the entire second site 2 and to expose the second site 2.

At the beginning of the exposure of the second site 2, the pattern center 352C of the mask pattern 352 is located at the first mask position m1, and the site center 364C of the first site 1 is located at the fourth substrate position s4 along the first axis.

As illustrated in FIG. 4D, once the entire second site 2 is fully within the shot area 476 of the field of view 474, the mask pattern 352 is imaged onto the second site 2. Basically, with the substrate 214A and mask 12 moving along the X axis, the mask pattern 352 is illuminated once the complete second site side 364B reaches the shot area 476.

As provided herein, the exposure process of the second site 2 continues until the entire second site 2 is no longer fully within the field of view 474.

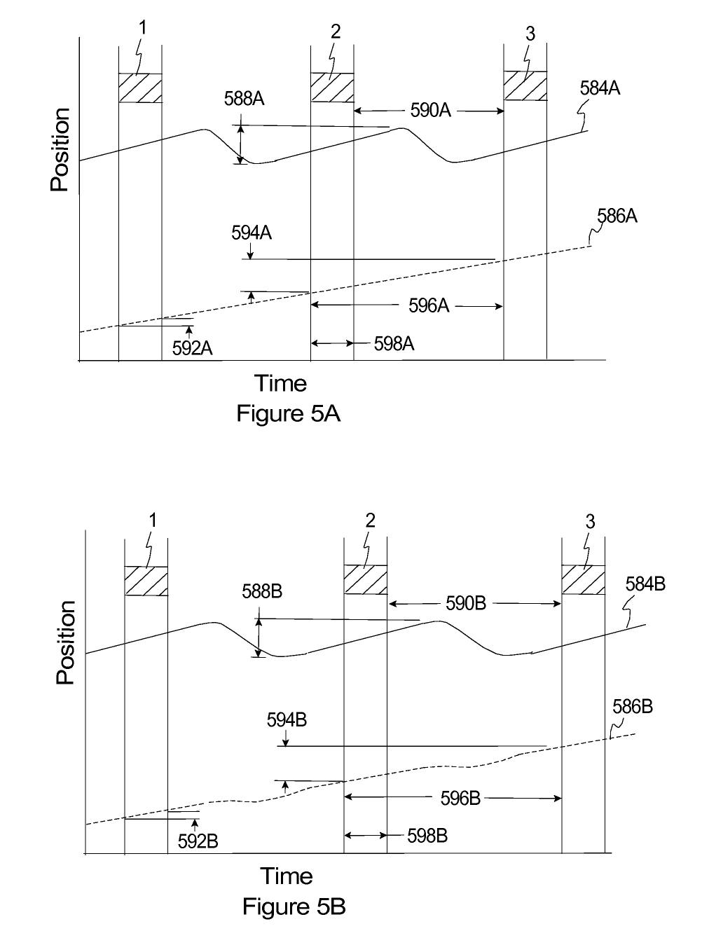

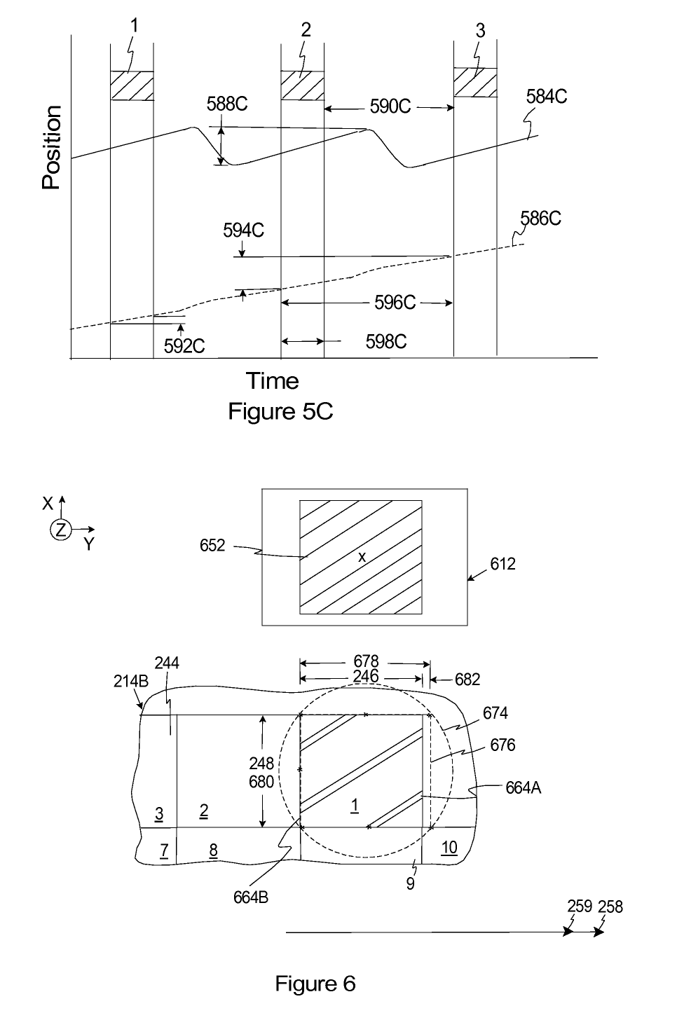

FIG. 5A is a graph that illustrates one example of the position of the mask 584A (illustrated with a solid line) and the position of the substrate 586A (illustrated with a dashed line) during the exposure of three adjacent sites (labeled 1, 2, 3) versus time.

FIG. 5A illustrates that the mask 584A and the substrate 586A are each being moved at a constant velocity (as illustrated by a constant change in position) during the exposure of each of the sites 1, 2, 3. Further, FIG. 5A illustrates that in this embodiment, the position of the substrate 586A is changing at the same rate during the entire time, and thus the substrate is also being moved at a constant velocity in between exposures. Moreover, FIG. 5A illustrates that the position of the mask 584A is reset in between the exposures. Thus, between sites, the mask 584A is (i) decelerated, (ii) subsequently accelerated in the opposite direction from which it was moving during exposure, (iii) decelerated again, and (iv) subsequently accelerated back to the exposure velocity in the exposure direction in preparation of exposing the next site.

FIG. 5A further illustrates (i) a mask stroke 588A which represents the entire movement stroke of the mask back and forth during and between exposures, (ii) a mask reset time 590A which represents the time required to reset the mask after an exposure to be ready for the subsequent exposure, (iii) a substrate exposure distance 592A which represents the distance that the substrate is moved during an exposure of a site, (iv) a shot width 594A that represents the distance the substrate is moved from the start of one exposure to the start of another exposure, (v) a shot time 596A that represents the time required to do a single exposure plus the time required to position the substrate for the exposure of the next site, and (vi) an exposure time 598A that represents the time required to expose a single site.

In one non-exclusive example, the exposure apparatus 10 (illustrated in FIG. 1) is designed so that (i) the substrate is moved at a constant velocity of approximately 0.34 meters/second, (ii) the mask stroke 588A is approximately 23 millimeters, (iii) the mask reset time 590A is approximately 66 milliseconds, (iv) the substrate exposure distance 592A is approximately 3.4 millimeters, (v) the shot width 594A is approximately 16 millimeters, (vii) the shot time 596A is approximately 76 milliseconds, and (viii) the exposure time 598A is approximately 10 milliseconds. However, it should be noted that apparatus 10 can be designed to have other values than that described in this paragraph to suit the exposure requirements of the substrate and the design parameters of the apparatus 10.

FIG. 5B is a graph that illustrates another example of the position of the mask 584B (illustrated with a solid line) and the position of the substrate 586B (illustrated with a dashed line) during the exposure of three adjacent sites (labeled 1, 2, 3) versus time.

In FIG. 5B, the mask 584B and the substrate 586B are each being moved at a constant velocity (as illustrated by a constant change in position) during the exposure of each of the sites 1, 2, 3. However, in FIG. 5B, the substrate is slowed down and is not being moved at a constant velocity between exposures. Stated in another fashion, the substrate stage assembly moves the substrate 586B at a slower velocity between the transfer of the mask pattern to the first site and the second site than during the transfer of the mask pattern to the first site and the second site.

Further, FIG. 5B illustrates that the mask 584B is again reset in between the exposures. However, with the slowing of the substrate in between exposures, the mask 584B does not have to be reset as quickly.

FIG. 5B further illustrates (i) a mask stroke 588B which is the same as the mask stroke 588A of FIG. 5A, (ii) a mask reset time 590B which is longer than the mask reset time 590A of FIG. 5A, (iii) a substrate exposure distance 592B which is the same as the substrate exposure distance 592A of FIG. 5A, (iv) a shot width 594B which is the same as the shot width 594A of FIG. 5A, (v) a shot time 596B which is longer than the shot time 596A of FIG. 5A, and (vi) an exposure time 598B which is the same as the exposure time 598A of FIG. 5A.

FIG. 5C is a graph that illustrates another example of the position of the mask 584C (illustrated with a solid line) and the position of the substrate 586C (illustrated with a dashed line) during the exposure of three adjacent sites (labeled 1, 2, 3) versus time.

In FIG. 5C, the mask 584C and the substrate 586C are each being moved at a constant velocity (as illustrated by a constant change in position) during the exposure of each of the sites 1, 2, 3. However, in FIG. 5C, the substrate is accelerated and is not being moved at a constant velocity between exposures. Stated in another fashion, the substrate stage assembly moves the substrate 586C at a faster velocity between the transfer of the mask pattern to the first site and the second site than during the transfer of the mask pattern to the first site and the second site.

Further, FIG. 5C illustrates that the mask 584C is again reset in between the exposures. However, with the speeding up of the substrate 586C in between exposures, the mask 584C will have to be reset quicker than in previous examples.

FIG. 5C further illustrates (i) a mask stroke 588C which is the same as the mask stroke 588A of FIG. 5A, (ii) a mask reset time 590C which is shorter than the mask reset time 590A of FIG. 5A, (iii) a substrate exposure distance 592C which is the same as the substrate exposure distance 592A of FIG. 5A, (iv) a shot width 594C which is the same as the shot width 594A of FIG. 5A, (v) a shot time 596C which is shorter than the shot time 596A of FIG. 5A, and (vi) an exposure time 598B which is the same as the exposure time 598A of FIG. 5A.

FIG. 6 is a simplified top illustration of another embodiment of the mask 612 and a portion of the substrate 214B shown in a side-by-side arrangement at the start of an exposure of the first site 1. As provided above, during the discussion of FIG. 2B, the exposure of subsequent sites on the substrate 214B occurs while the substrate 214B is moved along the Y axis.

FIG. 6 illustrates that the mask 612 includes the mask pattern 652 (illustrated as a box) that includes the features that are to be transferred to the substrate 214B. Further, in FIG. 6, the second site 2, the third site 3, and a portion of the seventh site 7, the eighth site 8, the ninth site 9, and the tenth site 10 are also illustrated. In this embodiment, each site 244 includes the first site side 664A, and the second site side 664B.

Additionally, in FIG. 6, the mask pattern 652 is illustrated as being approximately the same size as each site 244. However, in the event that the projection optical assembly 20 has a reduction factor of 4, the mask pattern 652 can be four times larger than the size of each site 244.

At the start of exposure of the first site 1, the illumination system 18 (illustrated in FIG. 1) illuminates (illustrated with slashes “/”) the entire mask pattern 652. This causes the image (illustrated with double slashes “//”) of the mask pattern 652 to be directed at the entire first site 1 and to expose the first site 1.

A field of view 674 (illustrated with a dashed circle) of the projection optical assembly 20 (see FIG. 1) is also shown in FIG. 6. In this embodiment, the field of view 674 again defines a rectangular shaped shot area 676 (illustrated with a dashed box with *'s) that is larger (along the direction of movement of the mask 612 and substrate 214B) than each individual site 244. More specifically, the shot area 676 has a shot length 678 (along the Y axis) and a shot width 680 (along the X axis). In this embodiment, because the substrate 214B is moved along the Y axis during the exposures, the projection optical assembly 20 is designed so that the shot width 680 is equal to the site width 248, and the shot length 678 is greater than the site length 246. Further, the difference between the shot length 680 and the site length 246 is referred to as a length difference 682. With this design, as provided herein, the substrate 214B can be moved the length difference 682 while still being exposed by the image of the mask pattern 652.

In the non-exclusive example provided above, each site 244 has the site length 246 of thirty-three (33) millimeters, and the site width 248 of twenty-six (26) millimeters. In this example, the shot width 680 can be approximately twenty-six (26) millimeters, and the shot length 678 that is greater than thirty-three (33) millimeters. As non-exclusive examples, the shot length 678 can be approximately 35, 36, 36.5, 37, or 37.5 millimeters. In these non-exclusive examples, the length difference 682 is approximately 2, 3, 3.5, 4, or 4.5 millimeters. However, different shot length 678 is possible by changing the design of the projection optical assembly 20.

As provided herein, once the entire first site 1 is fully within the field of view 674, the mask pattern 652 is imaged onto the first site 1. Basically, with the substrate 214B moving the first Y substrate direction 258 and mask 612 moving in the first Y mask direction 259, the mask pattern 652 is illuminated once the second site side 664B reaches the shot area 676, and until the first site side 664A begins to leave the shot area 676.

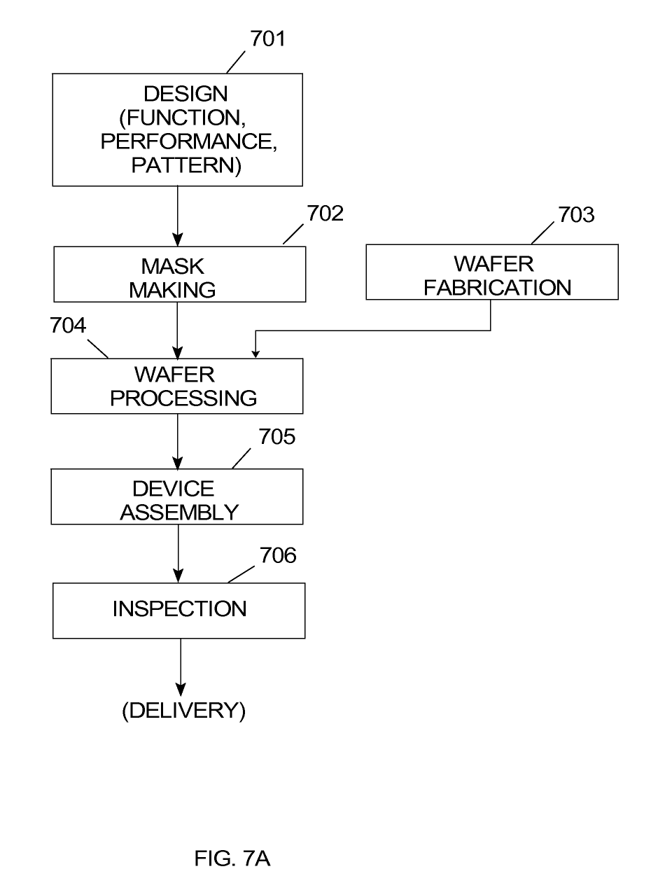

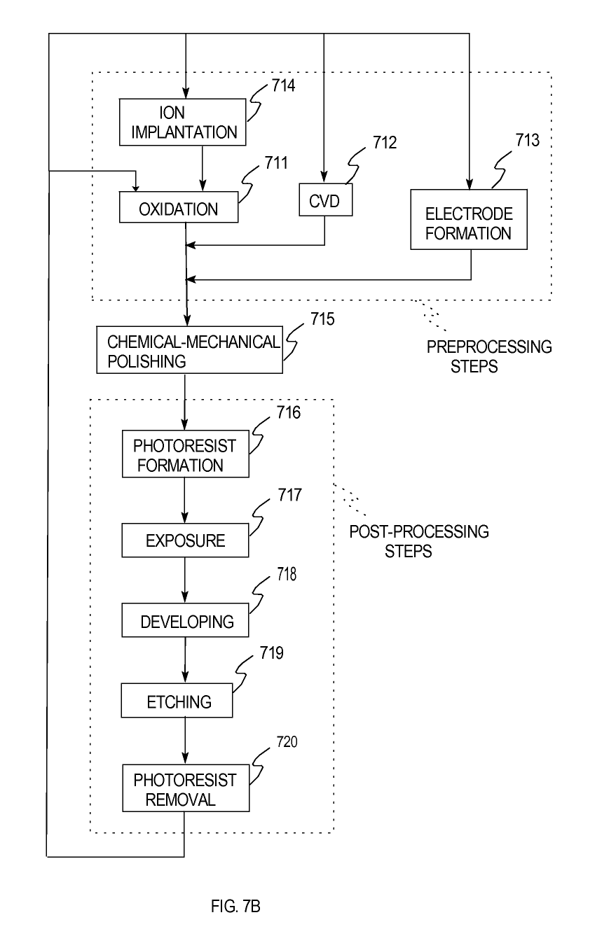

Semiconductor devices can be fabricated using the above described systems, by the process shown generally in FIG. 7A. In step 701 the device's function and performance characteristics are designed. Next, in step 702, a mask (reticle) having a pattern is designed according to the previous designing step, and in a parallel step 703 a wafer is made from a silicon material. The mask pattern designed in step 702 is exposed onto the wafer from step 703 in step 704 by a photolithography system described hereinabove in accordance with the present invention. In step 7105, the semiconductor device is assembled (including the dicing process, bonding process and packaging process), finally, the device is then inspected in step 706.

FIG. 7B illustrates a detailed flowchart example of the above-mentioned step 704 in the case of fabricating semiconductor devices. In FIG. 7B, in step 711 (oxidation step), the wafer surface is oxidized. In step 712 (CVD step), an insulation film is formed on the wafer surface. In step 713 (electrode formation step), electrodes are formed on the wafer by vapor deposition. In step 714 (ion implantation step), ions are implanted in the wafer. The above mentioned steps 711-714 form the preprocessing steps for wafers during wafer processing, and selection is made at each step according to processing requirements.

At each stage of wafer processing, when the above-mentioned preprocessing steps have been completed, optionally in step 715 the wafer can be polished using Chemical-Mechanical Polishing (“CMP”). Typically, CMP is done with certain layers depending upon the processing steps as required by the integrated circuit manufacturing process.

Subsequently, the following post-processing steps are implemented. During post-processing, primary, in step 716 (photoresist formation step), photoresist is applied to a wafer. Next, in step 717 (exposure step), the above-mentioned exposure device is used to transfer the circuit pattern of a mask (reticle) to a wafer. Then in step 718 (developing step), the exposed wafer is developed, and in step 719 (etching step), parts other than residual photoresist (exposed material surface) are removed by etching. In step 720 (photoresist removal step), unnecessary photoresist remaining after etching is removed. Multiple circuit patterns are formed by repetition of these preprocessing and post-processing steps.

The exposure apparatuses described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the particular exposure apparatuses as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An exposure apparatus for transferring a mask pattern from a mask to a substrate, the substrate including a first site and a second site that are adjacent to each other, the exposure apparatus comprising:
an illumination system that generates an illumination beam;
a substrate stage assembly that moves the substrate in a first substrate direction during the transfer of the mask pattern to the first site and the second site; and
a mask stage assembly that positions the mask relative to the illumination beam, the mask stage assembly moving the mask in a first mask direction during the transfer of the mask pattern to the first site and the second site, and the mask stage assembly moving the mask in a second mask direction that is opposite the first mask direction between the transfer of the mask pattern to the first site and the second site.

2. The exposure apparatus of claim 1 wherein the mask stage assembly moves the mask from a first mask position to a second mask position while the mask pattern is being transferred to the first site, and moves the mask from the first mask position to the second mask position while the mask pattern is being transferred to the second site.

3. The exposure apparatus of claim 2 wherein the mask stage assembly moves the mask from the second mask position to the first mask position in between when the mask pattern is being transferred to the first site and the second site.

4. The exposure apparatus of claim 1 wherein the substrate stage assembly moves the substrate without stopping the substrate during the transfer of the mask pattern to the first site and the second site.

5. The exposure apparatus of claim 1 wherein the substrate stage assembly moves the substrate at a substantially constant velocity in between when the mask pattern is being transferred to the first site and the second site.

6. The exposure apparatus of claim 1 wherein the substrate stage assembly moves the substrate at a faster velocity in between the transfer of the mask pattern to the first site and the second site than during the transfer of the mask pattern to the first site and the second site.

7. The exposure apparatus of claim 1 wherein the substrate stage assembly moves the substrate at a slower velocity between the transfer of the mask pattern to the first site and the second site than during the transfer of the mask pattern to the first site and the second site.

8. The exposure apparatus of claim 1 wherein the illumination beam illuminates the entire mask pattern at once.

9. A process for manufacturing a wafer that includes the steps of providing a substrate, and transferring a mask pattern to the first site and the second site of the substrate with the exposure apparatus of claim 1.

10. An exposure apparatus for transferring a mask pattern from a mask to a substrate, the substrate including a first site and a second site that are adjacent to each other and that are aligned with each other along a first axis, the exposure apparatus comprising:
an illumination system that generates an illumination beam;
a mask stage assembly that retains and positions the mask relative to the illumination beam;
a substrate stage assembly that retains and positions the substrate along the first axis; and
a control system that controls the illumination system, and the substrate stage assembly so that mask pattern is transferred to the first site and then subsequently to the second site, and wherein the substrate stage assembly is moving the substrate in a first substrate direction along the first axis when the mask pattern is being transferred to the first site and the second site.

11. The exposure apparatus of claim 10 wherein the control system controls the mask stage assembly so that the mask is being moved while the mask pattern is being transferred to the first site and the second site.

12. The exposure apparatus of claim 11 wherein the control system controls the mask stage assembly so that the mask is being moved in a first mask direction along the first axis while the mask pattern is being transferred to the first site, and the mask is being moved in the first mask direction along the first axis while the mask pattern is being transferred to the second site.

13. The exposure apparatus of claim 12 wherein control system controls the mask stage assembly so that the mask is being moved in a second mask direction along the first axis in between exposing the first site and the second site.

14. The exposure apparatus of claim 11 wherein control system controls the mask stage assembly so that the mask is being moved from a first mask position to a second mask position while the mask pattern is being transferred to the first site, and so that the mask is being moved from the first mask position to the second mask position while the mask pattern is being transferred to the second site.

15. The exposure apparatus of claim 14 wherein the control system controls the mask stage assembly to move the mask from the second mask position to the first mask position in between when the mask pattern is being transferred to the first site and the second site.

16. The exposure apparatus of claim 10 wherein the control system controls the substrate stage assembly to move the substrate without stopping the substrate during the transfer of the mask pattern to the first site and the second site.

17. The exposure apparatus of claim 10 wherein the control system controls the substrate stage assembly to move the substrate at a substantially constant velocity in between when the mask pattern is being transferred to the first site and the second site.

18. The exposure apparatus of claim 10 wherein the illumination beam illuminates the entire mask pattern at once.

19. The exposure apparatus of claim 10 further comprising an optical assembly positioned between the mask stage assembly and the substrate stage assembly, the optical assembly having a field of view that is bigger than the first site along the first axis.

20. A process for manufacturing a wafer that includes the steps of providing a substrate, and transferring a mask pattern to the first site and the second site of the substrate with the exposure apparatus of claim 10.

21. An exposure apparatus for transferring a mask pattern from a mask to a substrate, the substrate including a first site, the exposure apparatus comprising:
a mask stage assembly that retains and positions the mask along a first axis;
an illumination system that generates an illumination beam that illuminates the mask pattern corresponding to all of the first site at once;
a substrate stage assembly that retains and positions the substrate along the first axis; and
a control system that controls the mask stage assembly so that the mask is being moved in a first mask direction along the first axis and that controls the substrate stage assembly so that substrate is being moved along the first axis while the mask pattern is being transferred to the first site.

22. The exposure apparatus of claim 21 wherein the substrate includes a second site that is adjacent to the first site along the first axis, and wherein the control system controls the mask stage assembly so that the mask is being moved in the first mask direction along the first axis while the mask pattern is being transferred to the second site.

23. The exposure apparatus of claim 22 wherein the control system controls the mask stage assembly so that the mask is being moved in a second mask direction along the first axis in between exposing the first site and the second site.

24. The exposure apparatus of claim 22 wherein the control system controls the mask stage assembly so that the mask is being moved from a first mask position to a second mask position while the mask pattern is being transferred to the first site, and so that the mask is being moved from the first mask position to the second mask position while the mask pattern is being transferred to the second site.

25. The exposure apparatus of claim 24 wherein the control system controls the mask stage assembly to move the mask from the second mask position to the first mask position in between when the mask pattern is being transferred to the first site and the second site.

26. The exposure apparatus of claim 22 wherein the control system controls the substrate stage assembly to move the substrate without stopping the substrate during the transfer of the mask pattern to the first site and the second site.

27. The exposure apparatus of claim 26 wherein the control system controls the substrate stage assembly to move the substrate at a substantially constant velocity in between when the mask pattern is being transferred to the first site and the second site.

28. The exposure apparatus of claim 21 further comprising an optical assembly positioned between the mask stage assembly and the substrate stage assembly, the optical assembly having a field of view that is bigger than the first site along the first axis.

29. A process for manufacturing a wafer that includes the steps of providing a substrate, and transferring a mask pattern to the first site and the second site of the substrate with the exposure apparatus of claim 21.

30. An exposure apparatus for transferring a mask pattern from a mask to a substrate, the exposure apparatus comprising:
an illumination system that generates an illumination beam which illuminates the mask pattern which should be transferred to the substrate at one time;
a projection optical assembly that projects the mask pattern onto the substrate;
a mask stage assembly that retains and positions the mask relative to the projection optical assembly; and
a substrate stage assembly that retains and positions the substrate along a first axis; and wherein the substrate stage assembly continues moving the substrate in a first substrate direction along the first axis over a length of the substrate along the first axis during the projection of the mask pattern onto the substrate.

31. The exposure apparatus of claim 30 wherein the projection optical assembly has a field of view which is bigger than the mask pattern transferred to the substrate.

32. The exposure apparatus of claim 30 wherein the mask stage assembly is moving mask while the mask pattern is illuminated by the illumination beam.

33. An exposure apparatus for transferring a mask pattern from a mask to a substrate comprising:
an illumination system that generates an illumination beam which illuminates the portion of the mask pattern to be transferred to the substrate at one time;
a projection optical assembly that projects the mask pattern onto the substrate;
a mask stage assembly that retains and positions the mask relative to the projection optical assembly; and
a substrate stage assembly that retains and positions the substrate along a first axis; wherein the substrate stage assembly continues moving the substrate in a first substrate direction along the first axis over a length of the substrate along the first axis; and wherein the mask stage assembly moves the mask in a first mask direction along the first axis and reverses the mask and moves the mask in a second mask direction while the substrate stage assembly continues moving the substrate in the first substrate direction.

34. The exposure apparatus of claim 33 wherein the mask stage assembly moves the mask faster in the second mask direction than in the first mask direction.

35. A method for transferring a mask pattern from a mask to a substrate, the substrate including a first site and a second site that are adjacent to each other and that are aligned with each other along a first axis, the method comprising the steps of:
generating an illumination beam with an illumination system;
positioning the mask relative to the illumination beam with a mask stage assembly;
positioning the substrate along the first axis with a substrate stage assembly; and
controlling the illumination system, and the substrate stage assembly so that mask pattern is transferred to the first site and then subsequently to the second site, and wherein the substrate stage assembly is moving the substrate in a first substrate direction along the first axis when the mask pattern is being transferred to the first site and the second site.

36. The method of claim 35 further comprising the step of controlling the mask stage assembly so that the mask is being moved in a first mask direction along the first axis while the mask pattern is being transferred to the first site, and the mask is being moved in the first mask direction along the first axis while the mask pattern is being transferred to the second site.

37. The method of claim 36 further comprising the step of controlling the mask stage assembly so that the mask is being moved in a second mask direction along the first axis in between exposing the first site and the second site.

38. The method of claim 35 wherein the step of controlling includes the substrate stage assembly not stopping the substrate during the transfer of the mask pattern to the first site and the second site.

39. The method of claim 35 wherein the step of generating an illumination beam includes the illumination beam illuminating the entire mask pattern at once.

40. A method for transferring a mask pattern from a mask to a substrate, the substrate including a first site, the method comprising the steps of:
positioning the mask with a mask stage assembly along a first axis;
generating an illumination beam that illuminates the mask pattern corresponding to all of the first site at once with an illumination system;
positioning the substrate along the first axis with a substrate stage assembly;
controlling the mask stage assembly so that the mask is being moved in a first mask direction along the first axis while the entire mask is being transferred to the first site; and
controlling the substrate stage assembly so that substrate is being moved in a first substrate direction along the first axis while the mask pattern is being transferred to the first site.

41. The method of claim 40 wherein the substrate includes a second site that is adjacent to the first site along the first axis, and wherein the step of controlling the mask stage assembly includes controlling the mask stage assembly so that the mask is being moved in the first mask direction along the first axis while the mask pattern is being transferred to the second site.

42. The method of claim 41 wherein the step of controlling the substrate stage assembly includes controlling the substrate stage assembly to move the substrate without stopping the substrate during or between the transfer of the mask pattern to the first site and the second site.
